(19) United States
(12) Patent Application Publication
(10) Pub. No.: US 2010/0091294 A1
(43) Pub. Date: Apr. 15, 2010

(54) METHOD OF AND APPARATUS FOR MEASURING ELECTRIC FIELD VECTOR AND MICROSCOPE USING SAME

(75) Inventors: Dai Sik Kim, Seoul (KR); Kwang Geol Lee, Seoul (KR); Hyun Woo Kihm, Seoul (KR)

Correspondence Address: CANTOR COLBURN, LLP, 20 Church Street, 22nd Floor, Hartford, CT, 06103, US

(73) Assignees: SAMSUNG ELECTRONICS CO., LTD., Suwon-si (KR); SEOUL NATIONAL UNIVERSITY R & DB FOUNDATION, Seoul (KR)

(21) Appl. No.: 12/519,723

(22) PCT Filed: Mar. 23, 2007
(86) PCT No.: PCT/KR07/01432

§ 371 Date: Jun. 17, 2009

(30) Foreign Application Priority Data
Dec. 19, 2006 (KR) 10-2006-0130091

(51) Int. Cl. G01J 4/00; G01B 9/02

(52) U.S. Cl. 356/491; 356/364

(57) ABSTRACT

A system for measuring an electric field vector includes an optical extractor configured to extract an optical signal having a spatial resolution of a nanometer level. The optical signal corresponds to incident light at a measuring position within an examination area of a surface of a specimen. The system further includes a polarization analyzer for analyzing a polarization characteristic of the optical signal extracted by the optical extractor, and an electric field vector determinator for determining at least a size and an orientation axis of an electric vector at the measuring position using the polarization characteristic analyzed by the polarization analyzer.

### CROSS-REFERENCE TO RELATED APPLICATIONS

This application claims priority to Patent Cooperation Treaty Application No. PCT/KR2007/001432, filed on Mar. 23, 2007, and Korean Patent Application No. 10-2008-0130091, filed Dec. 19, 2006, and all the benefits accruing therefrom under 35 U.S.C. §§119 and 365, the contents of which in their entireties are herein incorporated by reference

### BACKGROUND

1) Field

The following description relates generally to measurement of an electric field vector, and, more specifically, to a method of and a system for measuring an electric field vector having a nanometer-level resolution, and to a microscope using the method and/or the system.

2) Description of the Related Art

When observing an object, either with a naked eye or with the aid of a microscope, for example, when a size of the object is less than half of a wavelength of measuring light, an image of the object cannot be seen due to a diffraction limit. Thus, scanning electron microscopes and atomic force microscopes have been developed to observe an object which is outside of an optical diffraction limit. The scanning electron microscope employs accelerated electrons, instead of visible light, to generate an image of an object. On the other hand, the atomic force microscope detects, at a nanometer level, an interactive force between atoms on a specimen surface and atoms on a tip of a probe. However, neither the scanning electron microscope nor the atomic force microscope are capable of measuring optical properties of an object or specimen.

A near-field scanning optical microscope has been designed to measure optical characteristics, on the order of nanometers, of an object outside of an optical diffraction limit. Some operational principles of the near-field scanning optical microscope are similar to operational principles of the atomic force microscope in many respects. Specifically, in the near-field scanning optical microscope, for example, a probe is brought close to a specimen surface, e.g., to a distance from which the probe can sense an interaction force from the surface.

The near-field optical microscope does not, however, measure interaction between atoms. Instead, the near-field optical microscope measures light, which originates from a specimen, e.g., is either emitted from or passing through the specimen, guided into the probe or scattered onto a tip of the probe. In contrast with a typical optical microscope, the near-field optical microscope does not employ a lens for condensing light to form an image, but instead moves the probe above a specimen to measure optical information thereof, which is thereafter used to generate an image of the specimen. Accordingly, an optical resolution of the near-field optical microscope is limited not by a diffraction limit, but by a size of the probe.

Near-field optical microscopes are categorized generally into one of two types, e.g., either an apertured near-field scanning optical microscope or an apertureless near-field scanning optical microscope, according to a type of probe used therein. In the apertured near-field scanning optical microscope, shown in FIG. 1, optical signals are received through a waveguide path, while in the apertureless near-field scanning optical microscope, shown in FIG. 2, measures optical signals scattered on the tip of the probe are measured.

More specifically, as shown in FIG. 1, a conventional apertured near-field scanning optical microscope includes an optical fiber probe 16 which is chemically treated. The optical fiber probe 16 includes an aperture 18 having a diameter less than 100 nm such that the optical fiber probe 16 can measure optical signals having a spatial resolution below a wavelength of visible light. A metallic thin film 17 is disposed on the optical fiber probe 16 and shields light from parts of the apertured near-field scanning optical microscope other than the aperture 18. An optical signal 11 is generated from a specimen 15 disposed on a stage 14. The optical signal 11 is supplied to the aperture 18 on a tip of the optical fiber probe 16 and is then guided into the optical fiber probe 16. A guided optical signal 13 is detected by a light detector (not shown) and thus the optical signal 11 of the specimen 15 is measured with a spatial resolution corresponding to a diameter of the optical fiber probe 16.

Referring to FIG. 2, a conventional apertureless near-field scanning optical microscope includes a metallic probe 23 having a tip which is pointed from a chemical treatment process, for example. When the metallic probe 23 is disposed above a specimen 25 on a stage 24, optical signals 21 emitted from a surface of the specimen 25 are scattered from a tip of the probe 23 to form scattered light 22. When the scattered light 22 is measured, an optical resolution thereof corresponds to a diameter of the tip of the metallic probe 23. Accordingly, in the apertureless scanning optical microscope, the metallic probe 23 does not have an aperture (as in the apertured near-field scanning optical microscope described above and shown in FIG. 1), and thus measures scattering of the optical signals 21 at the tip of the metallic probe 23. Thus, the apertureless scanning optical microscope provides high resolution power which is unattainable with an apertured near-field scanning optical microscope.

Optical signals measured with near-field scanning optical microscopes have a spatial resolution at the nanometer-level. However, as described above, only light intensity of the optical signals is measures, and information about an electric field component of the light is therefore not measured, because light intensity is a scalar quantity proportional to a square of the electric field. However, if a polarization of the scattered light is measured, an orientation of the electric field can be determined.

For example, as shown in FIG. 3, polarization properties of a specimen having a size larger than the wavelength of visible light can be measured by a conventional polarizing microscope. Specifically, the conventional polarizing microscope includes a first polarizer 32 for determining a polarization of incident light 31 incident on a specimen 35, a stage 34 on which the specimen 35 is disposed, and a second polarizer 37 for analyzing a polarization of the light 36 having a polarization characteristic which is changed when the specimen 35 has optical anisotropy.

More specifically, the incident light 31 is linearly polarized in one direction while passing through the first polarizer 32 to produce a linear-polarized beam 33 incident to the specimen 35 disposed on the stage 34. When the specimen 35 is optically anisotropic, the linear-polarized beam 33 is converted into the light 36 having a different polarization characteristic. An extent of change in polarization is analyzed while the light 36 passes through the second polarizer 37, which is a polarization-analysis plate 37. Thus, light 38 having information related to the change in polarization is measured to determine optical anisotropic properties of the specimen 35.

Thus, in the conventional polarizing microscope described above, light passing through a specimen is analyzed for polarization characteristics thereof to determine an optical axis of the specimen. However, optical axis is only one characteristic of the specimen, e.g., does not include other information regarding an electric field formed around the specimen. Thus, existing techniques can not measure an orientation of the electric field formed around the specimen and, more so, cannot measure the orientation of the electric field on the order of nanometers.

Accordingly, exemplary embodiments of the present invention have been made to solve at least the problems and/or disadvantages described above. Specifically, an exemplary embodiment of the present invention provides a method of and a system for measuring, with a nanometer-level resolution, a size and orientation axis of an electric field vector formed around a specimen. Exemplary embodiments of the present invention also provide a microscope using the method and/or the system.

An alternative exemplary embodiment of the present invention provides a method of and a system for measuring, with a nanometer-level resolution, an orientation of an electric field vector formed around a specimen, as well as a size and orientation axis thereof, and a microscope using the method and/or the system.

### SUMMARY

In an exemplary embodiment, a system for measuring an electric field vector includes: an optical extractor configured to extract an optical signal having a spatial resolution of a nanometer level, the optical signal corresponding to incident light at a measuring position within an examination area of a surface of a specimen; a polarization analyzer for analyzing a polarization characteristic of the optical signal extracted by the optical signal extractor; and an electric field vector determinator for determining at least a size and an orientation axis of an electric vector at the measuring position using the polarization characteristic analyzed by the polarization analyzer.

In an exemplary embodiment, the system for measuring an electric field vector further includes a phase difference analyzer for analyzing a phase difference by measuring an interference characteristic between the optical signal and the incident light. In this case, the electric field vector determinator further determines an orientation of the electric field vector using the polarization characteristic and the phase difference.

In an exemplary embodiment, the phase difference analyzer includes: a first optical divider member for branching a first branched light off from the incident light; a second optical divider member for branching a second branched light off from the optical signal; and an optical interferometer for analyzing a relative phase difference of the second branched light with respect to the first branched light by measuring interference characteristics of the first branched light and the second branched light.

In an exemplary embodiment, the optical extractor includes a probe having an aperture of nanometer-level disposed lengthwise therein, a probe having a tip of a nanometer-level diameter and/or a probe having a particle of a nanometer-level diameter disposed thereon.

In an exemplary embodiment, the polarization analyzer includes a polarizer which selectively passes the optical signal according to polarization characteristics thereof.

In an exemplary embodiment, the electric field vector determinator includes an optical detector.

In an exemplary embodiment, the system further includes an optical condenser for condensing the optical signal and an optical filter for screening the optical signal, condensed by the optical condenser, from other optical signals.

In an exemplary embodiment, the system further includes a recorder for continuously recording the electric field vector while changing the measuring position within the examination area to provide a two-dimensional distribution of the electric field vector within the examination area or a three-dimensional distribution of the electric field vector within the examination area.

In an exemplary embodiment, the polarization analyzer includes a first polarizer and a second polarizer, such that relative positions and orientations of the first polarizer and the second polarizer with respect to the optical signal are controlled to analyze a three-dimensional polarization characteristic of the optical signal.

According to an alternative exemplary embodiment, a method of measuring an electric field vector includes: extracting an optical signal having a spatial resolution of a nanometer level, the optical signal corresponding to incident light at a measuring position within an examination area of a surface of a specimen to generate an extracted optical signal; analyzing a polarization characteristic of the extracted optical signal to generate an analyzed polarization characteristic; and acquiring at least one of a size and an orientation axis of an electric vector at the measuring point using the analyzed polarization characteristic.

The method may further include analyzing a phase difference by measuring an interference characteristic between the optical signal and the incident light. In this case, the acquiring the at least one of a size and an orientation axis of the electric vector further includes acquiring an orientation of the electric field vector at the measuring point using the analyzed polarization characteristic and the phase difference.

In an exemplary embodiment, the analyzing the phase difference includes: branching a first branched light off from the incident light; branching a second branched light off from the optical signal; and analyzing a relative phase difference of the second branched light with respect to the first branched light by measuring interference characteristics of the first branched light and the second branched light.

In an exemplary embodiment, the extracting the optical signal is carried out using a probe having an aperture of a nanometer level disposed lengthwise therein, a probe having a tip of a nanometer-level diameter and a probe having a particle of a nanometer-level diameter disposed thereon.

In an exemplary embodiment, the analyzing the polarization analyzing step includes selectively passing the extracted optical signal, according to polarization characteristics thereof, by using a polarizer.

In an exemplary embodiment, the electric field vector acquiring step is performed by an optical detector.

In an exemplary embodiment, the method further includes condensing the extracted optical signal to generate a condensed optical signal and screening the condensed optical signal from other optical signals.

In an exemplary embodiment, the method further includes continuously recording the electric field vector while changing the measuring position within the examination area to provide a two-dimensional distribution of the electric field vector within the examination area or three-dimensional distribution of the electric field vector within the examination area.

In an exemplary embodiment, the analyzing the polarization characteristic includes of using a first polarizer and a second polarizer such that relative positions and orientations of the first polarizer and the second polarizer with respect to the extracted optical signal are controlled to analyze a three-dimensional polarization characteristic of the extracted optical signal.

According to still another alternative exemplary embodiment, a microscope for measuring an electric field vector includes the electric field vector measuring system as described in greater detail above.

Thus, according to exemplary embodiments of the present invention, characteristics of an electric field vector (e.g., size, orientation axis and/or orientation) are measured with a resolution of nanometers. In addition, using the measurement results, a distribution of electric field vectors in an examination area are mapped into a two- or three-dimensional form. Therefore, optical phenomena occurring in a structure having a size less than a few hundred nanometers, such as nano-particles, nano-holes and/or waveguide passageways, for example, are measured with substantially improved precision and in a substantially more interpretable way. In addition, exemplary embodiments of the present invention can be applied to bio-science research and development, such as precision measurement and study of optical properties emitted from quantum dots and fluorescent substances and interaction between the quantum dots or the fluorescent bodies, for example, but not being limited thereto.

### BRIEF DESCRIPTION OF THE DRAWINGS

The above and other aspects, features and advantages of the present invention will become more readily understood by describing in further detail exemplary embodiments thereof with reference to the accompanying drawings, in which:

FIG. 1 is a cross-sectional view of an apertured near-field scanning optical microscope of the prior art;

FIG. 2 is a cross-sectional view of an apertureless near-field scanning optical microscope of the prior art;

FIG. 3 is a cross-sectional view of a polarizing microscope of the prior art;

FIG. 4 is a cross-sectional view of an exemplary embodiment of a system and method for measuring electric field orientation using an apertureless probe according to the present invention;

FIG. 5 is a cross-sectional view of an alternative exemplary embodiment of a system and method for measuring electric field orientation using an apertured probe according to the present invention;

FIG. 6 is a graph of probe coordinates versus angles of polarization of an electric field having a standing wave form distribution measured at a probe tip of an exemplary embodiment of a system and method for measuring electric field orientation according to the present invention;

FIG. 7 is a graph of intensity versus position of a cross-sectional view of the electric field shown in FIG. 6 taken at angles of 0 degrees and 90 degrees along a vertical direction of a polarizer of an exemplary embodiment of a system and method for measuring electric field orientation according to the present invention;

FIG. 8 is a graph illustrating an orientation axis of the electric field shown in FIGS. 6 and 7;

FIG. 9 is a cross-sectional view of an exemplary embodiment of a system for measuring an electric field vector using an optical interferometer according to the present invention;

FIG. 10 is a cross-sectional view of an exemplary embodiment of the optical interferometer in shown in FIG. 9; and

FIG. 11 is a graph of intensity versus optical delay illustrating an exemplary embodiment of a method for converting an orientation of the electric field shown in FIG. 8 into a vector arrow indicating only one direction according to the present invention.

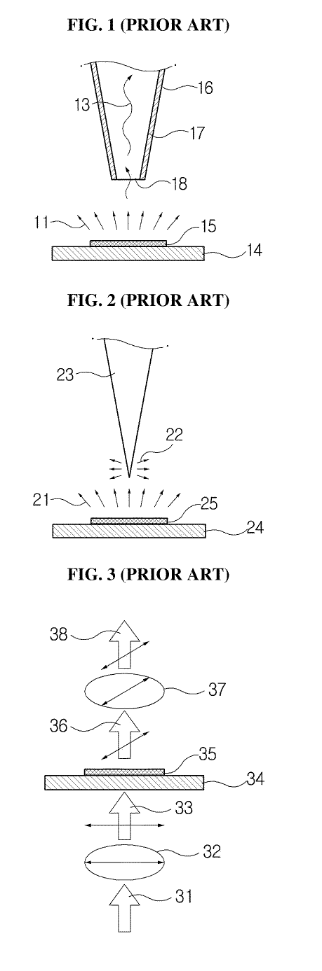

### DETAILED DESCRIPTION

The invention will now be described more fully hereinafter with reference to the accompanying drawings, in which exemplary embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

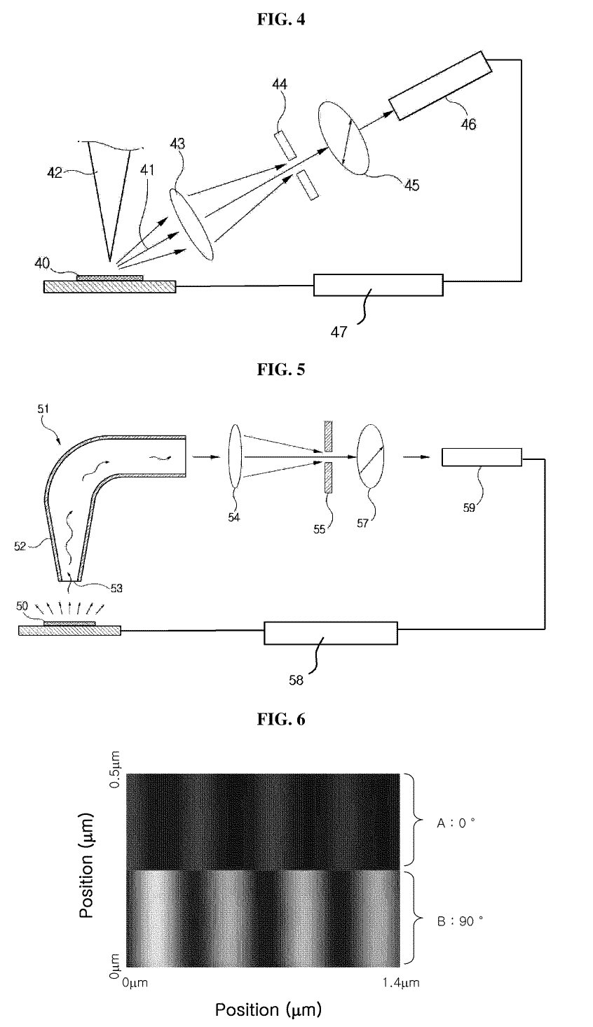

Hereinafter, an exemplary embodiment of a system for measuring an electric field vector will be described in further detail with reference to FIGS. 4 to 11.

FIG. 4 is a cross-sectional view of an exemplary embodiment of a system and method for measuring electric field orientation using an apertureless probe according to the present invention and, more particularly, for determination of a size and an orientation axis of an electric field vector.

Referring to FIG. 4, an electric field vector measuring system according to an exemplary embodiment includes an optical extractor 42, e.g., an apertureless probe 42, an optical condenser 43, e.g., an objective lens 43, an optical filter 44, e.g., an optical diaphragm 44, a polarization analyzer 45, e.g., a polarizer) 45, and an electric field vector determinator 46, e.g., an optical detector 46.

The apertureless probe 42 has a tip of a nanometer-order size, which generates a scattered light at measuring position. The apertureless probe 42 may be formed by chemically etching a metallic wire, for example. The metallic wire may include one of Au, Ag, W, Al, Cr and Cu. Alternatively, one of Au, Ag, W, Al, Cr and Cu may be coated on a surface of a chemically etched optical fiber to form the apertureless probe 43. In another alternative exemplary embodiment, the apertureless probe 43 may be formed by disposing Au nano particles on a top portion of a chemically etched optical fiber.

The objective lens 43 condenses the scattered light 41 at the measuring position. The optical diaphragm 44 filters the scattered light 41, condensed by the objective lens 43, from other lights. The polarizer 45 analyzes polarization characteristics of the scattered light 41 from the optical diaphragm 44. The polarizer 45 selectively transmits the scattered light 41 according to polarization characteristics thereof. The electric field vector determinator 46 acquires, e.g., determines, an orientation axis, a size and/or a distribution of an electric field at the measuring position, based on the polarization characteristics of the scattered light 41 analyzed by the polarizer 45.

The apertureless probe 42 is disposed above a surface of a specimen 40 to be measured. Scattered light 41 from a tip of the probe is condensed by the objective lens 43. The condensed light by the objective lens 43 forms an image proximate to the optical diaphragm 44. Positions of the objective lens 43 and the optical diaphragm 44 are adjusted such that a focal size of the image formed on the optical diaphragm 44 is a size which is controlled by the optical diaphragm 44.

An image of the scattered light 41 formed on the optical diaphragm 44 is sectioned to be discriminated from other images while controlling the size of the optical diaphragm 44. Consequently, other light, e.g., light other than the scattered light 41 on the tip of the apertureless probe 42, is screened from the light passing through the optical diaphragm 44. Thus, the optical diaphragm 44 overcomes a substantially weakness in a conventional apertureless near-field optical microscope (discussed above with reference to FIG. 2) wherein a weak optical signal results in a failure of measurement, e.g., the weak signal is smothered by, e.g., is overpowered by, other optical signals.

A polarization direction of the scattered light 41 screened in the optical diaphragm 44 is determined while the scattered light 41 passes through the polarization analyzer 45. The polarization direction is identical to, e.g., is substantially the same as, an electric field orientation axis at a place where the apertureless probe 42 is positioned. Thus, by moving the probe and/or the specimen, a distribution, size and/or orientation axis of the electric field in the measuring region is determined in either two or three dimensions.

Specifically, in an exemplary embodiment, the polarization analyzer includes two polarizers, e.g., a first polarizer and a second polarizer, such that relative positions and orientations of the two polarizers can be controlled with respect to the scattered light 41 screened in the optical diaphragm 44, thereby analyzing 3-dimensional polarization characteristics of the scattered light 41. More specifically, the first polarizer analyzes a vector component in the xy plane, for example, while the second polarizer analyzes a vector component in the yz plane, for example (where x, y and z are mutually orthogonal). Then, the vector component in the xy plane and the vector component in the yz plane are combined to obtain an electric field vector in an xyz spatial coordinate system, e.g., a three-dimensional coordinate system.

In an alternative exemplary embodiment, the system further includes a recorder 47 connected to electric field vector determinator 46, as shown in FIG. 4. The recorder 47 continuously records the electric field vector while changing a measuring position within the examination area to provide a two-dimensional distribution of the electric field vector within the examination area or, alternatively, a three-dimensional distribution of the electric field vector within the examination area.

In addition, the recorder 47 in an exemplary embodiment is a controlling unit of the specimen stage and the electric field vector determinator 46, which combines the scan position coordinate. The recorder 47 includes the method described in further detail above to acquire a 2-dimensional mapping of the electric field vector spatial distribution.

FIG. 5 is a cross-sectional view of an alternative exemplary embodiment of a system and method for measuring electric field orientation using an apertured probe according to the present invention which schematically shows a system for measuring an electric field vector where an apertured probe is used as the light extractor. In describing components of the exemplary embodiment shown in FIG. 5, any repetitive detailed description of the same or like components as those shown in FIG. 4 will be omitted.

Referring to FIG. 4, an apertured probe 51 according to an exemplary embodiment includes an optical fiber probe 51, which may be chemically treated, and may have an aperture diameter of no more than about 100 nm. Thus, the optical fiber probe 51 measures an optical signal having a resolution power below a visible light wavelength. A metallic thin film 52 is coated around, e.g., is disposed on, the optical fiber probe 51 such that optical signals are shielded from other than the aperture 53. Optical signals formed proximate to specimen 50 disposed on a stage are coupled to the aperture 53 at a tip of the optical fiber probe 51 and are guided into the optical fiber probe 51. The optical signals guided are condensed on the optical diaphragm 55 by the objective lens 54, and are screened from other lights by the optical diaphragm 55. A polarization characteristic is determined by the polarization analyzer 57 and, thereafter, a distribution, size and/or orientation axis of the electric field vector are obtained by, e.g., are determined by, the electric field vector determinator 59.

In an alternative exemplary embodiment, the system further includes a recorder 58 connected to electric field vector determinator 59, as shown in FIG. 5. The recorder 58 continuously records the electric field vector while changing a measuring position within the examination area to provide a two-dimensional distribution of the electric field vector within the examination area and/or a three-dimensional distribution of the electric field vector within the examination area.

In addition, the recorder 58 in an exemplary embodiment is a controlling unit of the specimen stage and the electric field vector determinator 59, which combines the scan position coordinate. The recorder 58 includes the method described in further detail above to acquire a 2-dimensional mapping of the electric field vector spatial distribution.

FIG. 6 is a graph of probe coordinates versus angles of polarization of an electric field having a standing wave form distribution measured at a probe tip of an exemplary embodiment of a system and method for measuring electric field orientation according to the present invention. As shown in FIG. 6, the vertical axis and the horizontal axis denote the probe coordinates on the specimen surface. Further, states of A and B are separated according to angles of the polarization analyzer plate during scanning; the angle of the polarization analyzer plate of A is 0 degrees (°) and the angle of the polarization analyzer plate of B is 90 degrees (°). Thus, FIG. 6 illustrates an intensity of scattered light measured at a tip of a probe while moving the probe on a specimen surface with a constant height from the surface fixing a polarization analyzer plate angle at a predetermined value.

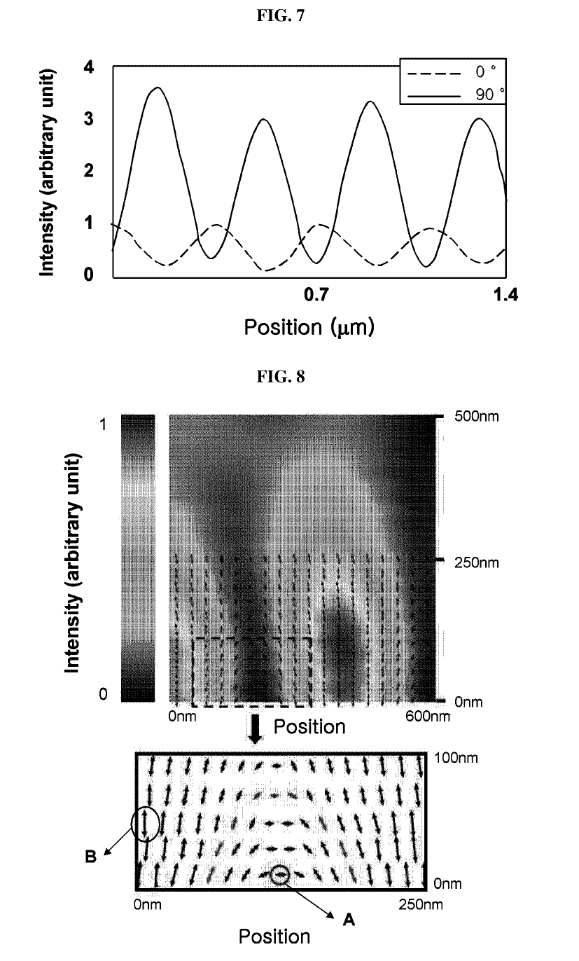

FIG. 7 is a graph of intensity versus position of a cross-sectional view of the electric field shown in FIG. 6 taken at the polarization analyzer plate angles of 0 degrees and 90 degrees. A dashed line denotes the intensity profile of state A shown in FIG. 6 with the polarization analyzer plate angle of 0°, and a solid line denotes the intensity profile of state B shown in FIG. 6 with the polarization analyzer plate angle of 90°. A distribution of measured scattered light is different at different angles of the polarizer of the polarization analyzer even though the probe has searched the same area. This indicates that the scattered lights at the probe tip, generated by electric fields existing on a surface of a specimen, are polarized. Thus, the orientation axis of an electric field at the place of the probe can be determined from these measurement results and the fact that polarization direction of a scattered light is substantially the same as an orientation axis of an electric field excited therefrom.

FIG. 8 illustrates a probe height dependent near-field intensity and the electric field orientation measurement result using an exemplary embodiment of a system and method for measuring an electric field orientation according to the present invention. In FIG. 8, the optical intensity distribution is presented using pseudo-value mapping which matches each value to a different intensity as indicated by value scale bar, and the orientation axes of electric field vectors are denoted by arrows.

In FIG. 8, the probe is raster scanned along the line in a horizontal direction while moving the probe farther away from the surface of the specimen. Thus, in an exemplary embodiment of an optical system, the probe is sent towards a given area of a specimen surface to measure and determine the orientation axis, size and distribution of an electric field at the given area. A highlighted area boxed with a dashed line in FIG. 8 shows the magnified version of electric field mapping. Arrows labeled with “A” and “B” indicate the horizontal and the orthogonal aligned electric fields, respectively. The fact that it is possible to draw line following the continuous flow of the arrow clearly indicates that the microscope of exemplary embodiments has sufficient spatial resolution to measure electric field lines.

However, the experimental results shown in FIGS. 6, 7 and 8 contain information of only the size and the orientation of electric field vector. Real electric field vectors with single direction are not available only with analyzing polarizer plate. For example, when electric fields have a phase difference of 180 degrees, e.g., when a first electric field has phase of 0 degrees and a second electric field has a phase of 180 degrees, analysis of the polarizer determines a same polarization characteristic and thus the two electric fields cannot be discriminated from one another. Consequently, analysis using a polarizer does not help in determining an electric field orientation axis, e.g., a single-arrow vector cannot be determined.

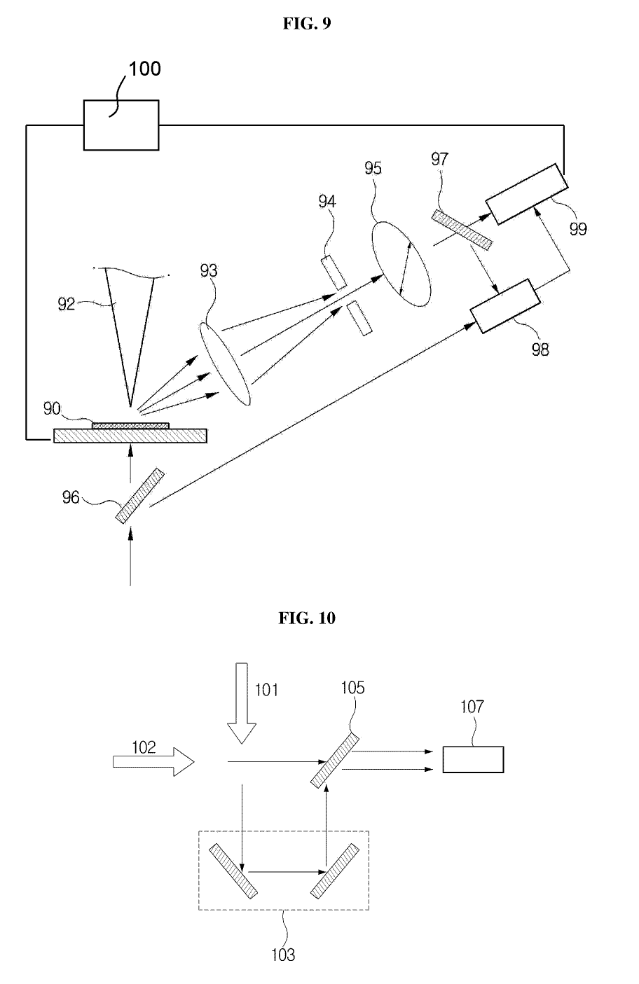

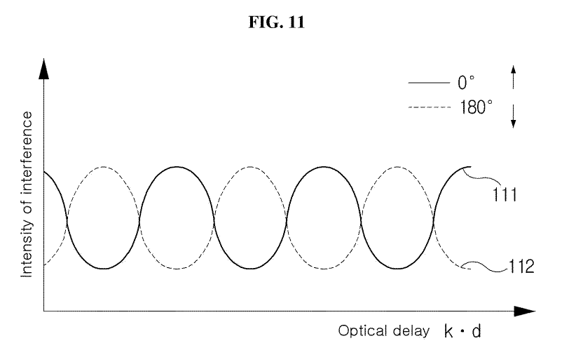

Thus, in an exemplary embodiment, a determination of size, orientation axis and/or direction of electric field vector is determined, as will now be described in further detail. FIG. 9 is a cross-sectional view of an exemplary embodiment of a system for measuring an electric field vector using an optical interferometer according to the present invention. FIG. 10 is a cross-sectional view of an exemplary embodiment of the optical interferometer in shown in FIG. 9.

An electric field vector measuring system according to an exemplary embodiment includes an optical extractor 92, e.g., an apertureless probe 92, an optical condenser 93, e.g., an objective lens 93, an optical filter 94, e.g., an optical diaphragm 94, a polarization analyzer 95, e.g., a polarizer 95, a phase difference analyzer, e.g., a first optical divider member 96 and a second optical divider member 97 and an optical interferometer 98, and an electric field vector determinator 99. Hereinafter, any repetitive detailed descriptions of the same or like components in the exemplary embodiment shown in FIG. 9 and as described in greater detail above with respect to alternative exemplary embodiments will be omitted.

The first optical divider member 96, e.g., the first optical divider member 96, branches a first branched light out from the light incident on a specimen 90. The second optical divider member 97, e.g., the second optical divider member 97, branches a second branched light out from the light for which its polarization properties are determined while passing through the specimen 90, the optical extractor 92, the optical condenser 93, the optical filter 94 and the polarizer 95 in sequence. The optical interferometer 93 measures interference characteristics of the first branched light and the second branched light to determine a relative phase difference of the second branched light with respect to the first branched light.

More specifically, as shown in FIG. 10, the first branched light 101 incident to the optical interferometer is reflected on mirrors 103, giving a change in an optical delay thereof, and then interferes with the second branched light 102 through a third optical divider member 105, e.g., a third optical divider member 105. This interference is analyzed using the interference measuring device 107 while changing a position of the mirrors 103, to thereby determine a phase difference of the light with respect to the incident light incident on the specimen 90.

In an alternative exemplary embodiment, the system further includes a recorder 100 connected to electric field vector determinator 99, as shown in FIG. 9. The recorder 100 continuously records the electric field vector while changing a measuring position within the examination area to provide a two-dimensional distribution of the electric field vector within the examination area or, alternatively, a three-dimensional distribution of the electric field vector within the examination area.

In addition, the recorder 100 in an exemplary embodiment is a controlling unit of the specimen stage and the electric field vector determinator 99, which combines the scan position coordinate. The recorder 100 includes the method described in further detail above to acquire a 2-dimensional mapping of the electric field vector spatial distribution.

An exemplary embodiment of a method for determining the orientation of an electric field using the phase difference of two lights will now be explained in greater detail with reference to mathematical equations within which “E” represents respective electric field vectors.

Specifically, the light incident on the specimen is expressed by a first equation [Equation 1]:

E₀=E₀e^{i(wt+φ}^{₀}⁾ [Equation 1]

Among the lights for which polarization characteristic are determined, a light having an optical delay of kd and a phase of 0 degrees is denoted by a second equation [Equation 2]:

E₁=E₁e^{i(wt+kd+φ}^{₁}⁾ [Equation 2]

Likewise, a light having a phase of 180 degrees is expressed by a third equation [Equation 3]:

E₂=E₂e^{i(wt+kd+φ}^{₁}^{+π)} [Equation 3]

As shown in FIG. 11 (graph 111), when the phase of an optical signal of which polarization characteristics are determined is 0 degrees, the interference with the light incident on the specimen is expressed by a fourth equation [Equation 4]:

|E₀+E₁|²=|E₀|²+|E₁|²+2E₀E₁ cos(kd+φ₁−φ₀) [Equation 4]

As shown in FIG. 11 (graph 112), when the phase of an optical signal of which polarization characteristics are determined is 180 degrees, the interference is exhibited according to a fifth equation [Equation 5]:

|E₀+E₂|²=|E₀|²+|E₂|²+2E₀E₂cos(kd+φ₁−φ₀+π) [Equation 5]

Thus, when the phase difference is 180 degrees, the interference characteristics analyzed by an optical interferometer can determine E₁ and E₂, which cannot be classified with polarization characteristics analyzed by a polarizer, have a phase difference of 180 degrees. The above-determined phase difference can be combined with the above determined polarization orientation to express an orientation of electric field as a vector.

FIG. 11 is a graph of intensity versus optical delay illustrating an exemplary embodiment of a method for converting an orientation of the electric field shown in FIG. 8 into a vector arrow indicating only one direction according to the present invention. When scattered light has a same polarization characteristic and a phase difference of 180 degrees, an orientation of electric field cannot be determined using polarization analysis alone.

However, in an exemplary embodiment which analyzes interference phenomenon between the light incident on a specimen and the optical signal (of which the polarization characteristic is determined), the phase of the interference characteristic has a difference of 180 degrees. Thus, the orientation of the electric field is effectively determined in one direction.

Thus, according to exemplary embodiments as described herein, characteristics of an electric field vector (e.g., size, orientation axis and/or orientation) are measured with a nanometer level resolution. In addition, using the measurement results, a distribution of electric field vectors in an examination area are mapped into a two- or three-dimensional form. Moreover, an orientation of the electric field vector is measured on the order of nanometers. Therefore, optical phenomena occurring in a structure having a size less than a few hundred nanometers, such as nano-particles, nano-holes and/or waveguide passageways, for example, are measured with substantially improved precision and in a substantially more interpretable way. In addition, exemplary embodiments can be applied to bio-science research and development, such as precision measurement and study of optical properties emitted from quantum dots and fluorescent substances and interaction between the quantum dots or the fluorescent bodies, but alternative exemplary embodiments are not limited thereto.

The present invention should not be construed as being limited to the exemplary embodiments set forth herein. Rather, these exemplary embodiments are provided so that this disclosure will be thorough and complete and will fully convey the concept of the present invention to those skilled in the art.

In addition, while the present invention has been particularly shown and described with reference to exemplary embodiments thereof, the description herein is illustrative only and is not to be construed as limiting the invention. It will be understood by those of ordinary skill in the art that various modifications and variations inform and detail may be made to the exemplary embodiments described herein without departing from the spirit or scope of the present invention as defined by the following claims.

1. A system for measuring an electric field vector, the system comprising:
an optical extractor configured to extract an optical signal having a spatial resolution of a nanometer level, the optical signal corresponding to incident light at a measuring position within an examination area of a surface of a specimen;
a polarization analyzer for analyzing a polarization characteristic of the optical signal extracted by the optical extractor; and
an electric field vector determinator for determining at least a size and an orientation axis of an electric field vector at the measuring position using the polarization characteristic analyzed by the polarization analyzer.

2. The system as claimed in claim 1, further comprising
a phase difference analyzer configured to analyze a phase difference by measuring an interference characteristic between the optical signal and the incident light, wherein the
electric field vector determinator further determines an orientation of the electric field vector at the measuring position, using the polarization characteristic and the phase difference.

3. The system as claimed in claim 2, wherein the phase difference analyzer comprises:
a first optical divider member for branching a first branched light off from the incident light;
a second optical divider member for branching a second branched light off from the optical signal; and
an optical interferometer for analyzing a relative phase difference of the second branched light with respect to the first branched light by measuring an interference characteristics of the first branched light and the second branched light.

4. The system as claimed in claim 1, wherein the optical extractor includes at least one selected from the group consisting of a probe having an aperture of nanometer level disposed lengthwise thereof therein, a probe having a tip of nanometer-level diameter and a probe having a particle of nanometer-level diameter disposed thereon.

5. The system as claimed in claim 1, wherein the polarization analyzer comprises a polarizer which selectively passes the optical signal based on polarization characteristics thereof.

6. The system as claimed in claim 1, wherein the electric field vector determinator comprises an optical detector.

7. The system as claimed in claim 1, further comprising:
an optical condenser for condensing the optical signal extracted by optical extractor; and
an optical filter for screening the optical signal condensed by the optical condenser from other optical signals.

8. The system as claimed in claim 1, further comprising a recorder for continuously recording the electric field vector determined by the electric field vector determinator while changing the measuring position within the examination area to provide one of a two-dimensional distribution of the electric field vector within the examination area and a three-dimensional distribution of the electric field vector within the examination area.

9. The system as claimed in claim 1, wherein
the polarization analyzer comprises a first polarizer and a second polarizer, and
relative positions and orientations of the first polarizer and the second polarizer with respect to extracted optical signal extracted by the optical extractor are controlled to analyze a three-dimensional polarization characteristic of the optical signal.

10. A method of measuring an electric field vector, the method comprising:
extracting an optical signal having a spatial resolution of a nanometer level, the optical signal being corresponding to incident light at a measuring position within an examination area of a surface of a specimen to generate an extracted optical signal;
analyzing a polarization characteristic of the extracted optical signal to generate an analyzed polarization characteristic; and
acquiring at least one of a size and an orientation axis of an electric vector at the measuring point using the analyzed polarization characteristic.

11. The method as claimed in claim 10, further comprising
analyzing a phase difference by measuring an interference characteristic between the optical signal and the incident light, wherein the
acquiring the at least one of a size and an orientation axis of the electric vector further includes acquiring an orientation of the electric vector using the analyzed polarization characteristic and the phase difference.

12. The method as claimed in claim 11, wherein the analyzing the phase difference includes:
branching a first branched light off from the incident light;
branching a second branched light off from the optical signal; and
analyzing a relative phase difference of the second branched light with respect to the first branched light by measuring interference characteristics of the first branched light and the second branched light.

13. The method as claimed in claim 10, wherein the extracting the optical signal comprises using at least one selected from the group consisting of a probe having an aperture of nanometer level disposed lengthwise therein, a probe having a tip of nanometer-level diameter and a probe having a particle of nanometer-level diameter disposed thereon.

14. The method as claimed in claim 10, wherein the analyzing the polarization characteristic includes selectively passing the extracted optical signal, according to polarization characteristics thereof, by a polarizer.

15. The method as claimed in claim 10, wherein the acquiring at least one of a size and an orientation axis of an electric vector is performed by of an optical detector.

16. The method as claimed in claim 10, further comprising:
condensing the extracted optical signal to generate a condensed optical signal; and
screening the condensed optical signal from other optical signals.

17. The method as claimed in claim 10, further comprising continuously recording the electric field vector while changing the measuring position within the examination area to provide one of a two-dimensional distribution of the electric field vector within the examination area and a three-dimensional distribution of the electric field vector within the examination area.

18. The method as claimed in claim 10, wherein the analyzing the polarization characteristic includes using a first polarizer and a second polarizer such that relative positions and orientations of the first polarizer and the second polarizer with respect to the extracted optical signal are controlled to analyze a three-dimensional polarization characteristic of the extracted optical signal.

19. A microscope for measuring an electric field vector, the microscope comprising an electric field vector measuring system, wherein the electric field vector measuring system comprises:
an optical extractor configured to extract an optical signal with a spatial resolution of a nanometer level, the optical signal corresponding to incident light at a measuring position within an examination area of a surface of a specimen;
a polarization analyzer for analyzing a polarization characteristic of the optical signal extracted by the optical extractor; and
an electric field vector determinator for determining at least a size and an orientation axis of an electric field vector at the measuring position using the polarization characteristic analyzed by the polarization analyzer.

20. The microscope as claimed in claim 19, wherein the electric field vector measuring system further comprises a phase difference analyzer configured to analyze a phase difference by measuring an interference characteristic between the optical signal and the incident light, wherein the electric field vector determinator further determines an orientation of the electric field vector at the measuring position using the polarization characteristic and the phase difference.
